(19) United States
(12) Patent Application Publication
(10) Pub. No.: US 2003/0099390 A1
(43) Pub. Date: May 29, 2003

(54) Lung field segmentation from CT thoracic images

(76) Inventors: Xiaolan Zeng, Santa Clara, CA (US); Wei Zhang, Union City, CA (US); Alexander C. Schneider, Sunnyvale, CA (US)

Correspondence Address: Pennie & Edmonds, LLP, 3300 Hillview Avenue, Palo Alto, CA, 94304, US

(21) Appl. No.: 09/993,793

(22) Filed: Nov. 23, 2001

(51) Int. Cl. G06K 9/00; G06K 9/34

(52) U.S. Cl. 382/131; 382/154; 382/173

(57) ABSTRACT

A method and system of volume segmentation is disclosed. To address throughput and accuracy issues, the segmentation is divided into two stages: presegmentation and detailed segmentation. In presegmentation, a digital image volume is segmented into different anatomical structures. In the detailed segmentation, additional processing over a limited range is performed. The result of the volume segmentation is a volume in which segmented regions of interest, such as nodules, are labeled or identified.

### CROSS-REFERENCE TO RELATED APPLICATIONS

Related applications are:

“Density Nodule Detection in 3-Dimensional Medical Images,” attorney docket number 8498-035-999, filed concurrently herewith;

“Method and System for the Display of Regions of Interest in Medical Images,” Ser. No. ______, filed Nov. 21, 2001, attorney docket number 8498-039-999;

“Vessel Segmentation with Nodule Detection,” attorney docket number 8498-042-999, filed concurrently herewith;

“Automated Registration of 3-D Medical Scans of Similar Anatomical Structures,” attorney docket number 8498-043-999, filed concurrently herewith;

“Pleural Nodule Detection from CT Thoracic hnages,” attorney docket number 8498-045-999, filed concurrently herewith, each of which is incorporated herein by reference; and

“Graphical User Interface for Display of Anatomical Information,” Ser. No. ______, filed Nov. 21, 2001, claiming priority from Serial No. 60/252,743, filed Nov. 22, 2000 and claiming priority from Serial No. 60/314,582 filed Aug. 24, 2001.

This application hereby incorporates by reference the entire disclosure, drawings and claims of each of the above-referenced applications as though fully set forth herein.

### FIELD OF THE INVENTION

The present invention relates to feature extraction and identification by segmenting an image volume into distinctive anatomical regions. The invention further relates to methods for generating efficient and accurate spatial relationships between segmented anatomic regions and methods for employing such models as an aid to medical diagnosis.

### BACKGROUND OF THE INVENTION

The diagnostically superior information available from data acquired from various imaging systems, especially that provided by multidetector CT (multiple slices acquired per single rotation of the gantry) where acquisition speed and volumetric resolution provide exquisite diagnostic value, enables the detection of potential problems at earlier and more treatable stages. Given the vast quantity of detailed data acquirable from imaging systems, various algorithms must be developed to efficiently and accurately process image data. With the aid of computers, advances in image processing are generally performed on digital or digitized images.

Digital acquisition systems for creating digital images include digital X-ray film radiography, computed tomography (“CT”) imaging, magnetic resonance imaging (“MRI”) and nuclear medicine imaging techniques, such as positron emission tomography (“PET”) and single photon emission computed tomography (“SPECT”). Digital images can also be created from analog images by, for example, scanning analog images, such as typical x-rays, into a digitized form. Further information concerning digital acquisition systems is found in our above-referenced copending application “Graphical User Interface for Display of Anatomical Information”.

Digital images are created from an array of numerical values representing a property (such as a grey scale value or magnetic field strength) associable with an anatomical location referenced by a particular array location. In 2-D digital images, or slice sections, the discrete array locations are termed pixels. Three-dimensional digital images can be constructed from stacked slice sections through various construction techniques known in the art. The 3-D images are made up of discrete volume elements, also referred to as voxels, composed of pixels from the 2-D images. The pixel or voxel properties can be processed to ascertain various properties about the anatomy of a patient associated with such pixels or voxels.

Once in a digital or digitized format, various analytical approaches can be applied to process digital anatomical images and to detect, identify, display and highlight regions of interest (ROI). For example, digitized images can be processed through various techniques, such as segmentation. Segmentation generally involves separating irrelevant objects (for example, the background from the foreground) or extracting anatomical surfaces, structures, or regions of interest from images for the purposes of anatomical identification, diagnosis, evaluation, and volumetric measurements. Segmentation often involves classifying and processing, on a per-pixel basis, pixels of image data on the basis of one or more characteristics associable with a pixel value. For example, a pixel or voxel may be examined to determine whether it is a local maximum or minimum based on the intensities of adjacent pixels or voxels.

Once anatomical regions and structures are constructed and evaluated by analyzing pixels and/or voxels, subsequent processing and analysis exploiting regional characteristics and features can be applied to relevant areas, thus improving both accuracy and efficiency of the imaging system. For example, the segmentation of an image into distinct anatomical regions and structures provides perspectives on the spatial relationships between such regions. Segmentation also serves as an essential first stage of other tasks such as visualization and registration for temporal and cross-patient comparisons.

Key issues in digital image processing are speed and accuracy. For example, the size of a detectable tumor or nodule, such as a lung nodule, can be smaller than 2 mm in diameter. Moreover, depending on the particular case, a typical volume data set can include several hundred axial sections, making the total amount of data 200 Megabytes or more. Thus, due to the sheer size of such data sets and the desire to identify small artifacts, computational efficiency and accuracy is of high priority to satisfy the throughput requirements of any digital processing method or system.

Thus, it is desirable to provide segmentation systems and methods for segmenting images that are not computationally intensive. It is also desirable that the segmentation systems and methods support various data acquisition systems, such as MRI, CT, PET or SPECT scanning and imaging. It is further desirable to provide segmentation systems and methods that support temporal and cross-patient comparisons and that provide accurate results for diagnosis. It is desirable to provide segmentation systems and methods for registering images that can handle 2-D and 3-D data sets. It is desirable to provide a segmentation approach that can be performed on partial volumes to reduce processing loads and patient radiation doses. It is further desirable to provide a segmentation process that provides results displayable on a computer display or that can be printed to support medical diagnosis and evaluation. The present invention provides a system and method that is accurate, flexible and displays high levels of physiological detail over the prior art without specially configured equipment.

### SUMMARY OF THE INVENTION

The segmentation algorithm of the present invention is based on use of digital or digitized images and the nature of images of anatomical structures of interest. To address throughput and accuracy issues, the segmentation process is divided into two stages: presegmentation and detailed segmentation. In presegmentation, a digital image volume is processed to identify body regions based on characteristics and features of anatomical structures of interest. Detailed segmentation involves segmenting further the body regions identified by presegmenting. One result of the overall volume segmentation algorithm is a volume in which segmented regions of interest, such as nodules are identified.

### BRIEF DESCRIPTION OF THE DRAWINGS

Objects, features and advantages of the invention will be more readily apparent from the following detailed description of a preferred embodiment of the invention in which:

FIG. 1 is a flow chart of a preferred segmentation algorithm of the present invention;

FIG. 2(a) is a flow chart depicting a pre-segmentation of body and lung field;

FIG. 2(b) illustrates a sample volume region;

FIGS. 3(a) and 3(b) depict axial image sections with thin anterior and posterior junctions as indicated with circles;

FIG. 4 depicts a reconstructed coronal image section; and

FIGS. 5(a) and 5(b) depict an axial image section and its lung field.

### DETAILED DESCRIPTION OF THE INVENTION

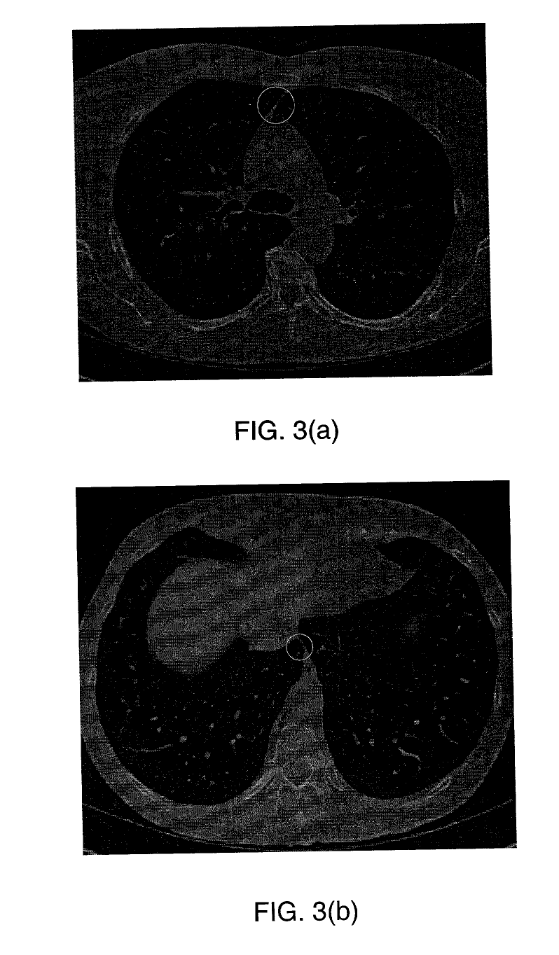

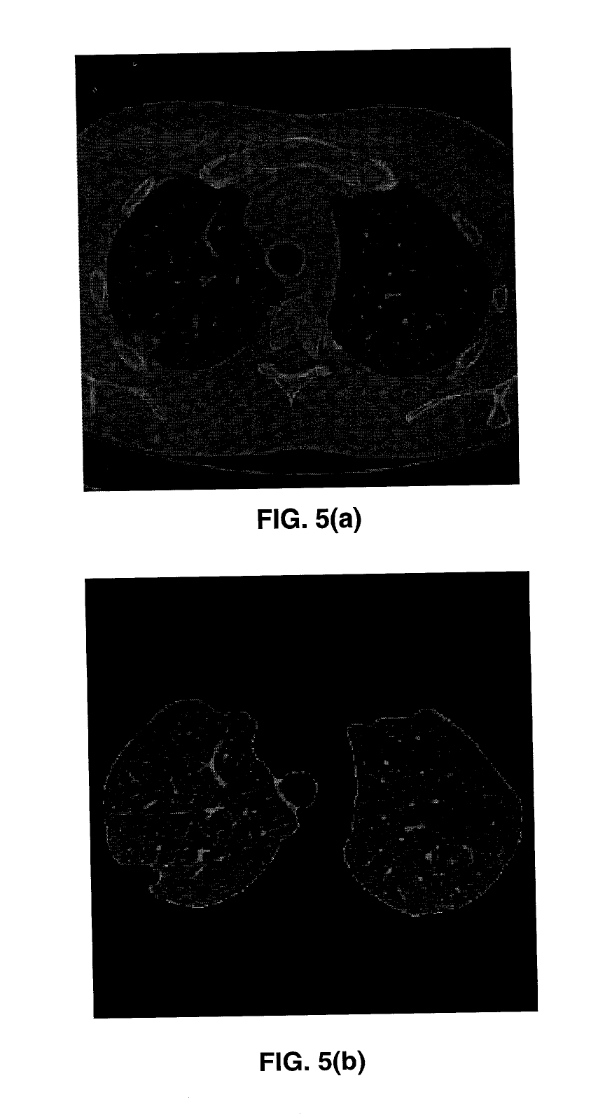

The present invention is preferably performed on a computer system, such as a Pentium™-class personal computer, running computer software that implements the algorithm of the present invention. The computer includes a processor, a memory and various input/output means. A series of CT axial or other digital images representative of a thoracic volume are input to the computer. Examples of such digital images or sections are shown in FIGS. 3(a), 3(b) and 5(a). FIG. 5(b) is a segmented lung field corresponding to the CT axial section of FIG. 5(a). The terms “digital” and “digitized” as used herein will refer to images or volumes, as appropriate, in a digital or digitized format acquired via a digital acquisition system or via conversion from an analog image.

The digital image sections to be processed, rendered, displayed or otherwise used includes digitized images acquired through any plane, including, without limitation, saggital, coronal and axial (or horizontal, transverse) planes and including planes at various angles to the saggital, coronal or axial planes. While the disclosure may refer to a particular plane or section, such as an axial section or plane, it is to be understood that any reference to a particular plane is not necessarily intended to be limited to that particular plane, as the invention can apply to any plane or planar orientation acquired by any digital acquisition system.

The software application and algorithm can employ 2-D and 3-D renderings and images of an organ or organ system. For illustrative purposes, a lung system is described. However, the methods and systems disclosed herein can be adapted to other organs or anatomical regions including, without limitation, the heart, brain, spine, colon, liver and kidney systems. While the renderings are simulated, the 2-D and 3-D imaging are accurate views of the particular organ, such as the lung as disclosed herein.

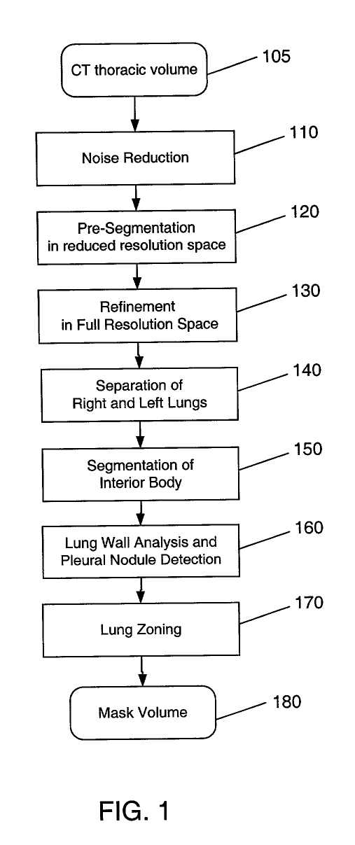

As shown in FIG. 1, the algorithm operates on a digital image volume 105 that is constructed from stacked slice sections through various construction techniques and methods known in the art. Data is preferably arranged to give a coronal or saggital view. An image, and any resulting image volume, may be subject to noise and interference from several sources including sensor noise, film-grain noise and channel errors. At step 110, optional, but preferable, noise reduction and cleaning is initially performed on the image volume 105. Various statistical filtering techniques can reduce noise effects, including various known linear and non-linear noise cleaning or processing techniques. For example, a noise reduction filter employing a Gaussian smoothing operation can be applied to the whole image volume or partial image volume to reduce the graininess of the image.

Following noise reduction, a presegmentation step 120 is performed to identify major portions (background, body and lungs) depicted in each digitized image. To improve computational efficiency, step 120 is performed in a space of reduced resolution. For example, a typical CT axial image is 512×512 array of 12-bit grey scale pixel values. Such an image has a spatial resolution of approximately 500 microns. In the presegmentation step, a resolution of 2000 microns is sufficient. In one approach of presegmentation, adjacent pixels in a digital image are locally averaged, using steps known in the art, to produce an image having a reduced resolution.

As noted, a key to digital volume segmentation is speed in handling throughput requirements and accuracy in finding nodules smaller than 2 mm in diameter. In the presegmentation stage an image volume is segmented, for example into different anatomical structures and volume fields, at low resolution. These structures and volume fields represent various major components of an anatomy, such as the lung(s), bones and heart of the image volume. Because of the lower resolution, as compared to a later-performed detailed segmentation at the resolution of the original image volume, presegmentation can be performed quickly. For more detailed segmentation that follows the presegmentation step 120, segmentation occurs at a higher resolution over additionally segmented regions.

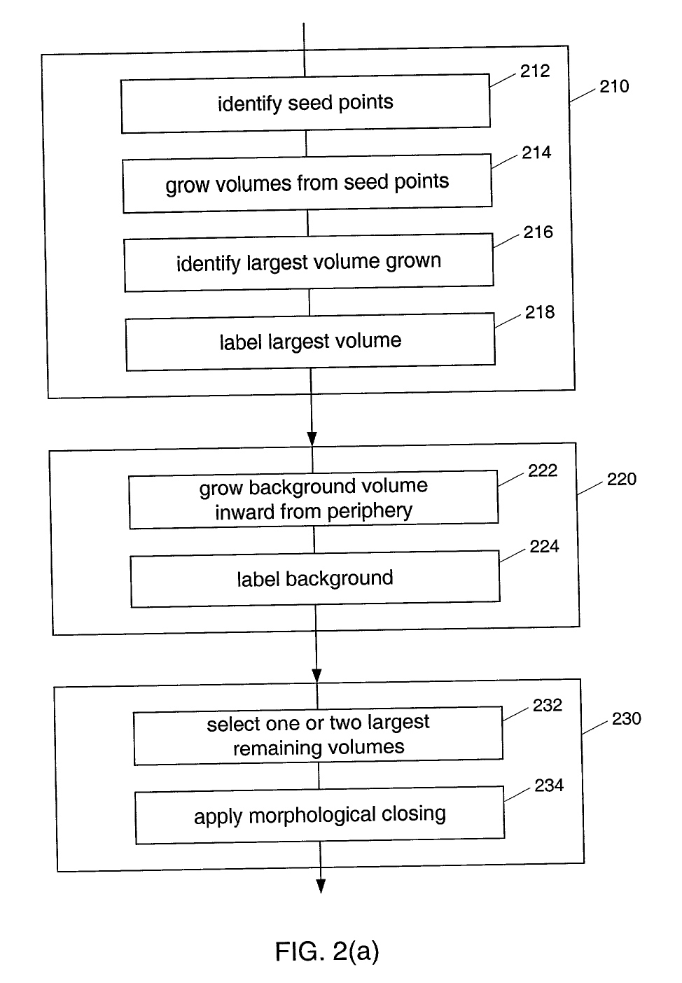

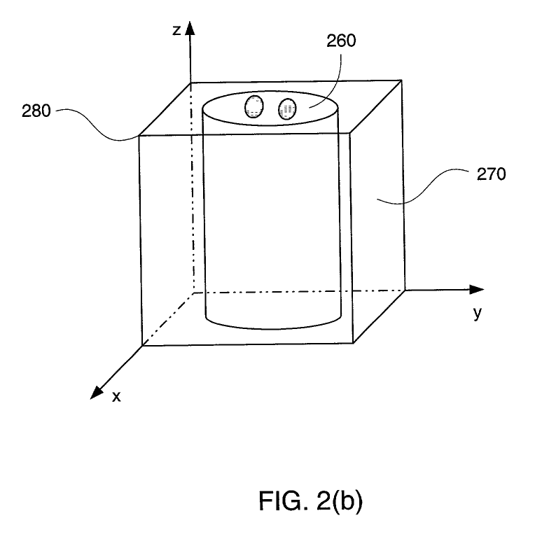

FIG. 2(a) is a flow chart depicting the presegmentation step in greater detail. In step 210, a coarse body region is segmented using 3-D region growing as well as size and connectivity analysis. Region growing is a segmentation-like algorithm designed to extract homogeneous regions from an image. Beginning with seed points and continuing with successive stages, merge merits are computed from neighboring pixels, voxels or region fragments, and a choice is made whether to add neighboring pixels, voxels, or fragments to the region being grown. The merits may depend on such properties as homogeneity, edge strength and other image attributes. The process usually stops when no acceptable merges remain to be made. The process can also be stopped artificially when a pre-defined condition is met for specific applications: for example, when the maximal size of the region is reached, or when the region touches certain locations flagged in the image.

Seed points are identified at step 212. Seed pixels or voxels are chosen to be highly typical of the region of interest or selected in the body region (including external and internal body regions) as voxels whose grey level intensities exceed a predetermined threshold. In one approach, seed voxels may be voxels whose grey level intensities exceed a first predetermined threshold. Volumes are then grown from seed points at step 214 to include regions brighter than a second predetermined threshold that specifies the minimal intensity for the body region. The single largest volume grown is then determined at step 216 and labelled at step 218 as the body. Structures not connected to the body but having similar intensities, such as the arms, are then excluded from the body volume. A sample volume region enclosing a body volume cubic 280 is shown in FIG. 2(b). The body volume cubic encloses body volume 260 and is bounded by side planes, such as side plane 270. At this point in the processing, the body volume generally includes an external body region, the mediastinum, the diaphragm and the vessels inside the lungs.

Next, the background is segmented at step 220. From four corner voxels on a digital image section, a background volume is grown inward at step 222 until it reaches the boundary of the volume previously labelled as the body. This step is based on the assumption that the entire lung field is enclosed by the body volume. Regions outside the body volume are labelled at step 224 as background. Described differently, background volume is segmented starting from one of four side planes 270 of the body volume cubic 280. The portion of the body volume cubic not enclosed in body volume 260 is considered part of the background.

Voxels that are not labelled either as body or background in the above steps are candidates for lung volume and the lung field is identified at step 230. Size and connectivity analysis are again applied at step 232 to select one or two largest connected volumes as the lung field. This deals with both cases where two lungs either appear to be separated in the image volume, or appear to be connected due to the narrow separation inbetween the two lungs such as separations identified by circles in FIGS. 3(a) and (b) and sometimes referred to as anterior and posterior junctions depending on their relative location. Three-dimensional feature analysis can be performed to select the lung volume and eliminate other anatomical structures and artifacts. For instance, morphological closing can be applied at step 234 to the captured lung field to fuse narrow breaks and holes within, thus recovering vessels into the lung field and achieving a smoother pleural boundary. Various morphological closing approaches “close” gaps in and between image objects where, in the case of a greyscale image, only the maximum values encountered are preserved.

The result from lung field segmentation in low resolution space is then interpolated back into the original resolution space at step 130 (FIG. 1) so as to identify the background, the body and the lung field in the full resolution images. Refinement at step 130 is performed at full resolution. For processing efficiency in lung-based images such modification optionally may be limited to the pleural area. In such cases, a narrow band is constructed around the pleural boundary. The width of the narrow band is determined based on the scale of the low resolution space used in step 120. Voxels inside the narrow band are then re-labelled according to their gray level intensities or other attributes, and morphological closing is applied to the refined lung region to form a smooth pleural boundary. For other organs or organ systems other linings, membranes or outlines may be used for partitioning the background and foreground.

In cases where the anterior/posterior junction tissue separating the two lungs is very thin, the tissue often gets included into the lung field due to certain processing steps described above such as thresholding and morphological operations. For accurate segmentation of right and left lungs, where the lung region on an axial slice forms a single connected piece, the tissue that separates the two lungs is recovered at step 140.

Such a recovery applies to lungs due to known characteristics related to lung anatomy. For the case of lung images, to perform anterior/posterior junction tissue recovery, operation is limited to the central part of the image by excluding the lateral body region. The connectivity from the anterior body region to the posterior body region through the mediastinum is examined. If no such connecting path exists, thin tissue is then grown from the anterior body region until it touches another part of the body region such as the mediastinum or the posterior body region. The grown thin tissue is then excluded from the lung field. If necessary, the same treatment is given to the posterior body region to exclude the thin tissue behind the heart from the lung field. For non-lung images, clearly recovery of anterior/posterior junction tissue would not be necessary. However, anatomical recovery or restoration may be required in a presegmentation step for different organs and systems based on organ or system characteristics where similar recovery considerations would apply.

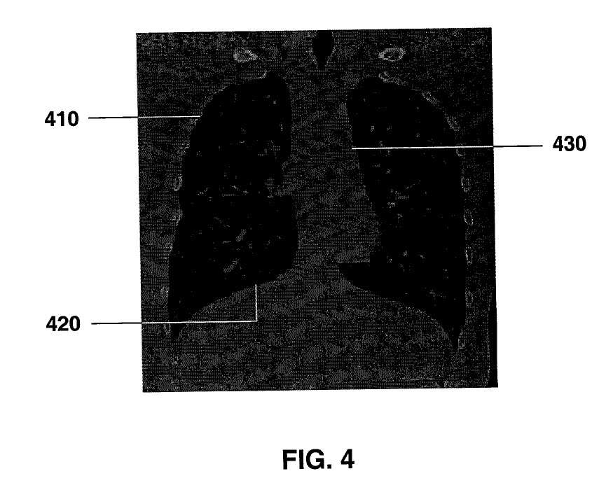

Next, the body volume is further segmented at step 150. At this step, specific image border points are identified on the basis of known characteristics of an anatomical region. For lungs, segmentation of the diaphragm 420 and mediastinum 430 is more conveniently done on a reconstructed coronal image section such as that shown in FIG. 4. Costal pleura 410, the portion of the pleura between the lungs and the ribs or sternum, is also shown. The coronal image is formed from the digital images using techniques known in the art. On the coronal image section, costal surface points are first identified as the lateral lung border points. The lower tip of the costal surface border separates the lung base from the costal surface; it is part of the inferior border of the lungs. Two inferior border points are thus located on each coronal image slice for right and left lungs respectively. A line connecting the two inferior border points is then drawn. The body region that is above this line and in-between costal surface border is re-labelled as the interior body region. Thus, the interior body region includes the mediastinum and the diaphragm.

The line connecting the two inferior border points is then deformed to fit the convex curve formed by the lung base. The resulting line is referred to as the lung base curve. The interior body region is then further classified as the mediastinum and the diaphragm according to its location (above or below, respectively) relative to the lung base curve.

Similar to the coarse body segmentation described above, region growing and size analyses are used for the segmentation of bone structures. As in the coarse body segmentation, a thresholding routine determines whether individual pixels or voxels are within a particular region by testing whether their values are within a range of values defined by one or more thresholds. The threshold for seed point selection and the intensity range for region growing are generally chosen according to Hounsfield Unit (HU) values of maximal and minimal bone densities or tissue regions. In volume or region growing techniques, and as further described with respect to steps 210 and 212, a seed voxel element is first identified within the anatomical structure of interest. Nearby voxels are “grown” to the seed voxel if such voxels are identified as belonging to the same structure of the seed voxel and the adjacent voxels meet a specified physical attribute, generally based on thresholding, texture analysis or other attribute-based analysis. For the lung region, the single largest connected piece of such grown region including the ribcage is labeled as bone. Such grown regions within the interior body are labeled as body calcifications (including cardiac calcifications).

In the above processing, large pleural nodules that show as promiment protrustions from the pleura are often lost due to their similarity in intensity to body volume. To ensure that such pleural nodules are included in the lung field, the pleura smoothness is analyzed at step 160. A deformable surface model using chamfer distance potential is used to obtain regularized pleural surfaces, from which the pleural nodules can be detected and recovered. More details on lung wall analysis and pleural nodule detection can be found in the above-referenced applications “Pleural Nodule Detection from CT Thoracic Images,” Ser. No. ______, and “Density Nodule Detection in 3-Dimensional Medical Images,” Ser. No. ______, both having been incorporated by reference.

Next, the organ or organ system is further segmented or zoned based on known characteristics of the organ. To fully utilize knowledge of lung anatomy and to facilitate effective nodule detection, the lung field is segmented at step 170 into lobes and special zones. For example, the costal peripheral zone can be easily identified as regions within a certain distance from costal surface points that lie on the border of the external body and lung field. The result of segmentation is passed onto subsequent processing 180 in the form of a mask volume, in which pixels that belong to each distinctive anatomical region or structure of interest are assigned different labels.

One advantage of the systems and methods disclosed herein is that it is not necessary that the segmentation algorithm be applied to a full volume of an organ or organ system. Volumes of a portion of an anatomical region or organ may be segmented by applying a subset of the processing steps described above in the application. Also, the segmentation routine can be applied to a partial volume constructed from image data. In this way, doctors can focus on a particular region of interest without applying the algorithm to the complete data set. Accordingly, the segmentation systems and methods provided support temporal and cross-patient comparisons and provide accurate results for diagnosis. Partial volume analysis reduces processing loads and, potentially, radiation dose to the patient.

The algorithm described herein is operable on various data acquisition systems, such as CT, PET or SPECT scanning and imaging. The results of the segmentation algorithm can be passed for subsequent processing in the form of a mask volume. Segmentation results can be also displayed on a graphical user interface (“GUI”) to provide comparison information for medical diagnosis and physiological evaluation. More details on the registration of temporal and cross-patient medical images can be found in “Automated Registration of 3-D Medical Scans of Similar Anatomical Structures,” Ser. No. ______, filed concurrently herewith and incorporated by reference above. The system and method can display various planar views and allows for highlighting ROIs and receiving user input regarding specific image data to be presented and selected. According to one system and method of the present invention, sets of 2-D and 3-D image sets are displayable on a GUI. Additionally, the GUI preferably allows for the selection and update of various planar and volumetric images by inputting commands (for example, by dragging/clicking a cursor in a particular display window) with no delay apparent to the user. Additionally, data volumes may be rotated, updated or selected with respect to fixed data. Accordingly, the algorithm disclosed herein provides segmentation systems and methods that support temporal and cross-patient comparisons and that provide accurate results for diagnosis displayable on a GUI or printed. More details on display of 2-D and 3-D images can be found in “Graphical User Interface for Display of Anatomical Information,” Ser. No. ______, which has been incorporated by reference above.

The algorithm disclosed herein is a step-by-step description of a segmentation algorithm and is illustrated for thoracic image processing and the thoracic anatomy and nature of lung images. The algorithm includes steps for thresholding, region growing, feature analysis, morphological closing and surface smoothness analysis. The present invention provides a system and method that is accurate, flexible and displays high levels of physiological detail over the prior art without specially configured equipment.

The foregoing examples illustrate certain exemplary embodiments of the invention from which other obvious embodiments, variations, and modifications will be apparent to those skilled in the art. The invention should therefore not be limited to the particular embodiments discussed above, but rather is defined by the claims.

What is claimed is:

1. A method of segmenting a volume from a series of digital images comprising the steps of:
forming an image volume from the series of digital images;
presegmenting the image volume to identify a body region; and
segmenting further the body region into anatomical volumes.

2. The method of claim 1 wherein the body region is a lung region.

3. The method of claim 1 further including the step of processing the anatomical volumes to identify one or more nodules.

4. The method of claim 3 wherein the one or more nodules includes at least one pleural nodule.

5. The method of claim 1 further including the step of processing the anatomical volumes to identify a boundary.

6. The method of claim 5 wherein the boundary is a pleural boundary.

7. The method of claim 1 wherein the step of segmenting further the body region includes forming a coronal section image.

8. The method of claim 1 wherein the step of segmenting further the body region includes identifying a diaphragm and a mediastinum.

9. The method of claim 1 wherein the step of further segmenting the body region is performed on the basis of known characteristics of anatomy corresponding to anatomical information in the digital images or anatomical volumes.

10. The method of claim 1 further comprising the step of processing the anatomical volumes to identify bone structures.

11. The method of claim 2 wherein the step further segmenting the lung region includes identifying a costal peripheral zone.

12. The method of claim 1 wherein the body region is a reduced resolution image.

13. The method of claim 1 further including the step of smoothing pleura.

14. The method of claim 1 wherein the step of presegmenting the image further comprises the steps of:
processing the image volume to create one or more reduced resolution volumes;
identifying in the one or more reduced resolution volumes one or more seed points at image voxels having gray level intensities exceeding a first predetermined threshold; and
growing a volume from the one or more seed points.

15. The method of claim 14 wherein the volume includes voxels having gray level intensities exceeding a second predetermined threshold.

16. The method of claim 14 wherein the step of presegmenting the image includes the step of identifying a background region.

17. The method of claim 14 wherein the step of presegmenting the image further comprises the step of growing the background region inwards from a periphery of the reduced resolution image to a volume identified as the body region.

18. The method of claim 17 wherein the step of presegmenting the image further comprises the steps of identifying grown volumes in the body region.

19. The method of claim 18 further including the step of selecting a largest volume from the grown volumes.

20. The method of claim 19 wherein the largest volume is a lung field.

21. The method of claim 18 wherein the two largest volumes grown is a lung field.

22. The method of claim 18 further comprises the step of applying morphological closing to a grown volume.

23. The method of claim 1 further including the step of reducing noise in the image volume.

24. The method of claim 23 wherein the step of reducing noise is performed by a Gaussian smoothing operation.

25. The method of claim 23 wherein the step of reducing noise is performed on an anatomical volume.

26. The method of claim 4 further including the step of applying morphological closing to the boundary to form a smooth boundary.

27. The method of claim 1 further including the step of recovering anatomical details.

28. The method of claim 27 wherein the recovered anatomical details is anterior or posterior junction tissue.

29. The method of claim 3 wherein the step of segmenting includes segmenting the lung region into zones.

30. The method of claim 27 further comprising the step of assigning pixels of one in the series of digital images or anatomical volumes to different zones.

31. The method of claim 1 further comprising the step of creating a mask volume.

32. The method of claim 1 wherein the series digital images depicts a thoracic region.

33. The method of claim 1 wherein the anatomical volume includes an organ.

34. The method of claim 33 wherein the organ is a heart, brain, spine, colon, liver or kidney.

35. A computer system including software for segmenting anatomical information in a series of computer digital images of the lung comprising:
logic code for forming an image volume from the series of digital images;
logic code for presegmenting the image volume to identify a body region; and
logic code for segmenting the body region into anatomical volumes.

36. The computer system of claim 35 further including logic code for processing the segmented images to identify one or more nodules.

37. The computer system of claim 35 further comprising logic code for processing the digital images to form a coronal section image.

38. The computer system of claim 37 further comprising logic code for processing the coronal section image to identify the diaphragm and the mediastinum.

39. The computer system of claim 35 further comprising software for processing the digital images to identify the costal peripheral zone.

40. The computer system of claim 34 wherein the logic code for presegmenting the image comprises:
logic code for identifying seed points at image voxels having gray level intensities exceeding a first predetermined threshold;
logic code for growing volumes from the seed points to include voxels having gray level intensities exceeding a second predetermined threshold;
logic code for identifying the body region; and
logic code for growing a background region inwards from a periphery of the reduced resolution image to a volume identified as the body region.

41. A method of segmenting information to identify organ nodules comprising the steps of:
forming from the digital images a series of reduced resolution images;
processing the reduced resolution images to identify a reduced resolution body region and a reduced resolution background region;
using the identification of the reduced resolution body region and the reduced resolution background region to identify a body region and a background region in the digital images;
processing the digital images to identify the organ boundary; and
processing the digital images to identify organ nodules.

42. The method of claim 41 wherein the organ boundary is a pleural boundary.

43. The method of claim 40 wherein the organ nodules are pleural nodules.

44. The method of claim 41 wherein the step of processing the reduced resolution images to identify a body region and a background region comprises the steps of:
identifying in the reduced resolution images seed points at image voxels having gray level intensities exceeding a first predetermined threshold;
growing volumes from the seed points to include voxels having gray level intensities exceeding a second predetermined threshold;
identifying the body region as the largest volume grown; and
growing the background region inwards from the periphery of the reduced resolution image to the volume identified as the body region.
